(19) United States
(12) Patent Application Publication
(10) Pub. No.: US 2010/0119919 A1
(43) Pub. Date: May 13, 2010

(54) Electrochemical Air Breathing Voltage Supply and Power Source Having in-situ Neutral-pH Electrolyte

(76) Inventors: Alex Iarochenko, Orillia (CA); Abram Shteiman, Thornhill (CA)

Correspondence Address: Elias Borges, Suite 406, 555 Burnhamthorpe Road, Toronto, M9C 2Y3, CA

(21) Appl. No.: 12/555,169

(22) Filed: Sep. 8, 2009

Related U.S. Application Data
(60) Provisional application No. 61/095,020, filed on Sep. 8, 2008.

(51) Int. Cl. H01M 2/08; H01M 4/04

(52) U.S. Cl. 429/35; 148/557

(57) ABSTRACT

The invention is a metal air fuel cell consisting of a cathode contained in a housing, the housing having an air passage through which air (O₂ gas) can pass to the cathode. The air passage is sealed by a gas (i.e. O₂) permeable membrane. The fuel cell further includes an anode made of a metal selected from the group of metals including aluminum, zinc, magnesium, and alloys thereof. The cathode and anode are electrochemically coupled by an electrolyte such that the cathode and anode are capable of electrochemically reacting to consume O₂ gas at a volume rate of V when producing a desired electrical current of I. The gas permeable membrane has a gas permeability rate and a surface area through which O₂ gas can pass through the gas permeable membrane to the cathode, the surface area and the gas permeability rate of the gas permeable membrane selected to permit O₂ gas to pass through the membrane at a rate Vₘ substantially equal to V at the desired current I. The permeable membrane is configured to reduce the transfer of water vapor through the membrane.

### CROSS REFERENCE TO RELATED APPLICATION

This application claims priority from U.S. Provisional Patent Application No. 61/095,020 filed Sep. 8, 2008, entitled “Electrochemical Air Breathing Voltage Supply and Power Source Having in-situ Neutral-pH Electrolyte” by Iarochencko et al, which application is incorporated herein by reference in its entirety.

### FIELD OF THE INVENTION

This invention relates to metal-air electrochemical batteries and fuel cells particularly aluminum-air electrochemical systems.

### DESCRIPTION OF THE PRIOR ART

There are known several types of the air breathing cells, which contain a series of basic components including a gas diffusion cathode—air electrode, a metal anode and neutral electrolyte. One type of these cells is a magnesium/oxygen battery based on a magnesium anode which uses seawater as the neutral pH electrolyte and oxygen as the oxidant. The electrochemistry of the cell is the dissolution of magnesium at the anode, 2Mg=2Mg²⁺+4e⁻, and consumption of oxygen at the cathode, O₂+2H₂O+4e⁻=4OH⁻, which can be written in a chemical form taking into account of magnesium corrosion in aqueous solutions 3Mg+O₂+4H₂O=3Mg(OH)₂+H₂⇑.

The value of this corrosion can be several milliampere per square centimeter in equivalent quantity of current density. It's known like severe self-discharge and current leakage problem due to chemical reaction even battery does not provide useful electrical current. Anodes of these classes also can be selected from the group consisting of the mixture magnesium, zinc, and alloys thereof.

This type of batteries generally degrades during storage due to corrosion of the anode material, whether the batteries are loaded or not. The corrosion results of the following, viz, problems of the battery housing sealing, because of the evolution of gas (hydrogen) build-up internal pressure inside of the battery housing; loss of available energy and cell voltage; production of unwanted by-products and so on.

Second type of these cells is a zinc-air battery based on a zinc anode dissolving usually in alkaline electrolyte (e.g. consisting of NaOH or KOH solution). The zinc-air alkaline batteries have significant advantage—serious corrosion problems of Zn can be readily inhibited. Because dangerous and corrosive alkaline electrolyte is necessary to promote enough power and energy efficiency, that is why the zinc-air battery not suitable for neutral pH electrolyte.

Third type of these cells is an aluminum/oxygen (air) battery based on an aluminum anode dissolving in a neutral-pH electrolyte, which usually contains halide salts (namely sea salt).

Aluminum as an anode metal for air breathing battery has high amp capacity and energy density, lightweight. Moreover, aluminum is inexpensive and abundant.

The electrochemistry of the cell is the dissolution of aluminum at the anode,

4Al=4Al³⁺+12e⁻,

and consumption of oxygen at the cathode,

3O₂+6H₂O+12e⁻=12OH⁻,

or in a chemical form

4Al+3O₂+6H₂O=2(Al₂O₃.3H₂O).

The mentioned redox reaction will go on if the cell gives power to an external device. In addition to the redox reaction there is a corrosion reaction to form hydrogen. But in a silent regime or shelf life, when the cell is not discharging and load current is zero, the corrosion reaction does not proceed in the neutral-pH electrolyte. So, the aluminum cell (in contrast to magnesium cell) does not have corrosion self-discharge during storage or “silent regime”. This problem appears during storage in case of the alkaline electrolyte.

U.S. Pat. No. 4,925,744 discloses aluminum-air battery comprising a novel cells connecting in a stack. Each cell consists of two compartments: bottom compartment—an electrolyte chamber having a consumable aluminum anode plate, a cathode sheet spaced from the anode and an electrolyte between the anode and the cathode; upper one—an electrolyte reservoir having in the top a hydrogen venting membrane closed for electrolyte. The preferred alkaline electrolyte with concentration 4-6 mol/L comprises else an anti-forming agent and corrosion inhibitor—aqueous stannate solution. All metal anodes in this patent have hydrogen corrosion rate at least 10 milliamps per square centimeter in preferred electrolyte. It means the battery embodiment is evolving hydrogen gas in volume about 3-4 hundred milliliters per hours or more. In addition the evident water evaporation occurs in each cell because the cathode sheet is fully opened to the air environment. In view of aforesaid the embodiment of the battery can be used as a short-time power supply having stand-by energy loss during hour at least 1.35 Wh or more.

Novel configuration of electrodes and design of the metal air cells were disclosed in EP Application No. 0,263,683 A2 and U.S. Pat. No. 6,869,710 B2. Typical embodiment of the foregoing cells is containing an anode, a cathode and an electrolyte. The anode electrode is formed of two parts each of them having a side complementary each sides of the cathode electrode. Oxygen from ambient air or reservoir comes into the inner air/oxygen plenum of the cell. It is obvious that the air inlets aren't adequate balanced with power and current generated from the batteries. In preferred embodiment of the EP Application No 0,263,683 A2, the metal anode plate is aluminum in saline electrolyte. The battery must be in vertical oriented position for release of hydrogen gas generated by electrochemical reaction within cell. In U.S. Pat. No. 6,869,710 B2 the preferred embodiment of the cell contains the anode from Zn particles, the air/oxygen cathode and a gel electrolyte in a mix with Zn particles. The cell electrolyte comprises very corrosive alkaline materials such as KOH, NaOH, LiOH, RbOH, CsOH or combination foregoing. The cathode may be bi-functional or if it is obviated, the third electrode serves as a charging electrode.

U.S. Pat. No. 6,544,686 B1 relates to the method of reduction hydrogen corrosion in Zn-air cells comprising an anode from Zn particles, a cathode, a corrosive alkaline electrolyte and polyethylene glycol (PEG) derivatives. But the PEG derivatives are unstable in saline aqueous electrolyte; totally the PEG derivates can deposits in presence of all nonorganic salt e.g. saline salts.

US Patent Application No. 2007/0141462 Al preferably relates to a method for reducing water loss of the hydrogen-oxygen fuel cell/battery due to alkali and hydrophilic additives having one or more functional groups effective for bonding water. The fuel includes the anode, the cathode, alkaline electrolyte with complicated hydrophilic additives and PEM permitting passage of protons generated at the anode through the membrane to the cathode. All cell embodiments include dangerous and corrosive alkaline compound electrolyte. The preferred electrolyte base is potassium hydroxide and has a molarity of 6 mol/L.

PCT/US98/12586 relates to membrane for air/oxygen and water vapor management for rechargeable metal-air battery especially Zn-air, because drying out and flooding are greater problem for this type of battery. A suitable electrolyte is a corrosive aqueous alkali such as LiOH, NaOH, KOH, and/or CsOH. During normal operation, the cell should be oriented so that the anode is above the cathode. All PCT/US98/12586 embodiments have one gas-permeable and liquid-impermeable membrane extending across the air side of the cathode and sealing electrolyte within the cell case. Second membrane is the oxygen/water vapor management having oxygen permeability 5−8,6×10⁻⁷ cm³ cm⁻² s⁻¹ cmHg⁻¹ and selectivity O₂/H₂O about 2.8-3.9. But the embodiment permeability put up resistance that's why a useful electrochemical reaction will be slowed down notably. Besides the management membrane is very complicated and expensive for manufacturing and tiny for running.

U.S. Pat. No. 6,492,046B1, EP 1,145,357 B1, EP 1,191,623 A2, U.S. Pat. No. 6,759,159B1 and U.S. Pat. No. 7,097,928 B1 are pointed on the effective air flow and distribution management preferably for Zn-air alkaline cell/battery having inlet openings to supply with air/oxygen. There are an electrical air mover systems and manual control e.g. when in U.S. Pat. No. 7,097,928 B1 the cartridge is in “of” mode the air openings are completely misaligned and contra versa. Some embodiments of the metal-air battery have a membrane with variable thickness and louvers for effective distribution of air to all parts of the cathode. Certainly, the electrical air mover systems are consuming energy from the battery.

U.S. Pat. No. 6,500,576B1 relates preferably to Zn-air cell including a cathode, an anode in form of Zn particles in a mixture of corrosive alkaline gel. Hydrogen recombination catalysts are incorporated within the gel-like anode in enough density (almost on each Zn particles) for reduction of hydrogen. During storage, the air access is covered by “seal tab” which protecting cell from drying out but in operation mode water loss existing. The embodiments of the cells have complex compound and expensive.

While the above referenced air breathing battery designs have their advantages, the key problem of maximizing the power output of an air breathing battery/fuel cell while at the same time maximizing life of the battery by preventing the drying out of the battery/fuel cell has remained unanswered.

### SUMMARY OF THE PRESENT INVENTION

An object of the present invention is to develop of the metal-air battery/fuel cell as a power source, which operates at high power densities in a neutral pH electrolyte suitable for electronic devices especially portable.

It is also an object of the present invention to provide a metal-air battery/fuel cell design which allows for thin, flat and flexible cells in order to provide flexible battery design.

Another object of the present invention is to provide an improved electrochemical battery/fuel cell assembly capable of operating in the absence of the evolved hydrogen gas and which can be run in any position and which can be stored for long periods of time without deteriorating.

A still further object is to provide a fuel cell which is environmentally and ecologically clean throughout its full life cycle, including manufacture, use, and recycling or disposal and which has a lowered cost of both manufacture and usage.

In order to accomplish the above objects, a metal air fuel cell made in accordance with the present invention includes a cathode contained in a housing, the housing having an air passage through which air (O₂ gas) can pass to the cathode, the air passage being sealed by a gas (i.e. O₂) permeable membrane. The fuel cell further includes an anode made of a metal selected from the group of metals including aluminum, zinc, magnesium, and alloys thereof. The cathode and anode are electrochemically coupled by an electrolyte such that the cathode and anode are capable of electrochemically reacting to consume O₂ gas at a volume rate of V when producing a desired electrical current of I. The gas permeable membrane has a gas permeability rate and a surface area through which O₂ gas can pass through the gas permeable membrane to the cathode, the surface area and the gas permeability rate of the gas permeable membrane selected to permit O₂ gas to pass through the membrane at a rate Vₘ substantially equal to V at the desired current I.

In accordance with another aspect of the present invention is a metal air fuel cell having a housing with a first pair of flat cathodes contained in a parallel orientation within the housing. The housing has first air passages through which air (i.e. O₂ gas) can pass to the first pair of flat cathodes. The metal-air fuel cell also includes a first pair of flat anodes positioned between the first pair of flat cathodes and extending parallel thereto, the anodes being made of a metal selected from the group of metals including aluminum, zinc, magnesium, and alloys thereof. The metal air fuel cell also includes a second pair of flat cathodes positioned between the first pair of flat anodes and extending substantially parallel thereto, the second pair of flat cathodes enclosing a second air passage, the second air passage being coupled to the housing to permit air to pass to the second pair of cathode plates. The first and second pairs of cathode plates are electrochemically coupled by an electrolyte to the first pair of anode plates, the electrolyte selected such that the anode plates and the cathode plates are capable of electrochemically reacting to consume O₂ gas to produce a desired electrical current.

In accordance with another aspect of the present invention is a metal air fuel cell having a housing and an elongated electrochemical cell contained within the housing. The elongated electrochemical cell consists of an elongated flat anode sandwiched between a pair of elongated flat cathode, the elongated flat anode being made of a metal selected from the group of metals including aluminum, zinc, magnesium, and alloys thereof. The elongated flat cathode and elongated flat anodes are electrochemically coupled by an electrolyte, the electrolyte selected such that the elongated flat anode and the elongated flat cathodes are capable of electrochemically reacting to consume O₂ gas to produce a desired electrical current. The elongated electrochemical cell is folded to form a plurality of folds separated by air gaps.

In accordance with another aspect of the present invention is a metal air fuel cell which has a housing containing a cathode, the housing having an air passage through which air (i.e. O₂ gas) can pass to the cathode. The fuel cell also includes an anode made of a metal selected from the group of metals including aluminum, zinc, magnesium, and alloys thereof combined with an additive selected from the group including Ga, In, Sn, Cd and Pb. The cathode and anode are electrochemically coupled by an electrolyte, the electrolyte selected such that the cathode and anode are capable of electrochemically reacting to consume O₂ gas to produce a desired electrical current.

In accordance with another aspect of the present invention there is provided an improved metal air fuel cell which has a housing containing a cathode, the housing having an air passage through which air can pass to the cathode. The housing further contains an anode made from a metal selected from the group of metals including aluminum, zinc, magnesium, and alloys thereof. The cathode and anode are electrochemically coupled by an electrolyte selected such that the cathode and anode are capable of electrochemically reacting to consume O₂ gas to produce a desired electrical current. The electrolyte including a pH neutral gelled solution of saline at a concentration of about 5% by weight.

In accordance with another aspect of the present invention, there is provided an improved metal-air fuel cell which has a housing containing a cathode,

the housing having an air passage through which air can pass to the cathode. The metal-air fuel cell also includes an anode made of a metal selected from the group of metals including aluminum, zinc, magnesium, and alloys thereof. The cathode and anode are electrochemically coupled by an electrolyte selected such that the cathode and anode are capable of electrochemically reacting to consume O₂ gas to produce a desired electrical current. The cathode consists of a three layered cathode having a substantially gas impermeable hydrophilic layer, a gas permeable hydrophobic layer containing a current collector mesh and a transition layer between the hydrophobic and hydrophilic layers, the transition layer being progressively more hydrophilic from the hydrophobic layer towards the hydrophilic layer. The cathode is oriented in the housing such that the hydrophilic layer is adjacent the electrolyte.

### BRIEF DESCRIPTION OF THE DRAWINGS

The preferred embodiments of the present invention will now be described in drawings, wherein:

FIG. 1 is a perspective view of an embodiment of the quadruple fuel cell battery.

FIG. 2a is a cross sectional view of the battery FIG. 1.

FIG. 2b is a detailed view of the two main parts of the battery FIG. 1.

FIG. 3 is an exploded perspective view of the inner main part of the FIG. 2.

FIG. 4 is an exploded perspective view of the battery FIG. 1.

FIG. 5 is a partially cut-away a perspective view of an embodiment of the multi-sectional fuel cell battery.

FIG. 6 is a perspective view of the first and second multi-sectional cathodic parts of the battery shown in FIG. 5.

FIG. 7 is a perspective view of the multi-sectional anodic part of the battery shown in FIG. 5 and its arrangement in battery housing.

FIG. 8 is a schematic layout of the battery shown in FIG. 5.

FIG. 9 shows plots of changes of the hydrogen corrosion density measured in ml per min. and per square cm of the anode surface as a function of anode current density per square cm of the anode surface and saline concentrations percentage by weight.

FIG. 10 is a schematic cross sectional view of the air cathode fragment.

FIG. 11 is a simplified schematic layout of the film mask.

FIG. 12 is a cross sectional view of an alternate embodiment of the present invention.

### DETAILED DESCRIPTION OF THE INVENTION

The objects of the present invention are achieved by developing a novel structure concept and design of the metal-air battery/fuel cell for a power supply, which being up state in a neutral pH electrolyte, said power supply includes single cell or a plurality of them and possibly other suitable assemblies/frames/cases or flexible taping structures and so on.

Each cell comprised of multiple sandwich or sandwich-layer structures where some of them is the air cathode/bi-cathodes interior and/or exterior members and adjacent anode members facing to active surface of the corresponding cathode members.

The other sandwich or sandwich-layers are wettable porous structures, which soaked by neutral pH electrolyte including aqueous solution of the saline salt, alcohol, glycerin and starch in the strongly defined optimum proportion stopping hydrogen corrosion in the metal-air battery/fuel cell under the load and drying out.

The anode formed of a material selected from the group consisting of aluminum, zinc, magnesium, and alloys thereof, and can comprise one or more additives of Ga, In, Sn, Cd, Pb in effective amount. The preferred anode material is aluminum alloy with indium additive, which in alloy mixture proceeded thermomechanical treatment.

Because of the Al is in the invention a preferred metal for the anode; the electrochemical evaluation of energy density and comparison was made in regard to the following selected metals as Al, Zn, and Li.

The maximum amount of energy W per mol, which is available to do work from Al, Li or Zn in electrochemical reaction, is equal to the change in Gibbs free energy, ΔG. These relationships can be expressed as

W=ΔG=−nFE°_{cell},

where

n is the number of electrons transferred per mole;

F is the Faraday constant;

E°_{cell}—Standard electrode potential: for Al=−1.66V, Zn=−0.76V, Li=−3.04V.

Comparison of the energy density between Al and Zn gives volumetric ratio: Wal/Wzn)_{Vl}=3/2×1.66/0.76=3.276. It means the volumetric energy density of Al in ˜3.3 times more then of Zn. The Gravimetric ratio is (Wal/Wzn)_{Gr}=3.276×(65:27)=7.9. It means the gravimetric energy density of Al in ˜8 times more then of Zn.

Comparison of the energy density between Al and Li gives volumetric ratio: (W_{Li}/W_{Al})_{Vl}=1/3×3.04/1.66=0.61. It means the volumetric energy density of Al in ˜1.63 times more then of Li The gravimetric ratio is (W_{Li}/W_{Al})_{Gr}=0.61×(27:6.94)=2.37. It means the gravimetric energy density of Li in ˜2.37 times more then of Al.

Despite the fact that Mg is more active (even it corrosive unloaded in neutral pH aqueous electrolyte) then Al, energy density both metals almost the same.

Hence, aforesaid analysis and evaluation convinces that Al is one of the best anodic material for air-breathing battery because in the invention the following drawbacks were overcame:
The corrosion problem, when the battery is run under the load a long time continuously;
A uniform dissolving of aluminum anode, when a current is generating under the electrochemical reaction.

The air/gas diffusion cathode is multi-layers and has at least a current collector mesh, a gas non-permeable hydrophilic active layer consisting of a high dispersion porous carbon and a gas permeable hydrophobic layer. In invention the preferred air/gas diffusion cathode includes additional transient layer which decreasing rate of the electrolyte drying out.

The film mask covers the air/gas diffusion cathode. The hole(s) in the mask are closed by means of the hydrophobic gas penetrated membrane. The covered hole(s) in the mask is defined sufficiently in accordance with venting rate of the membrane and electrochemical reaction which taking place in metal-air fuel cell, preferably Al-air fuel cell.

FIG. 1 shows a perspective view of the first embodiment of the quadruple fuel cell battery 10 having two cathodes 12 (bi-cathode), battery frame case 24 closed by first and second case covers 26, 28. There are cathode taps 14 and anode tap 18 onto the side of the cover 26 and air inlet tubule 32 with cathode leading-out wire 22 onto the side of the cover 28. Each part of the battery housing 24, 26, and 28 has gas-evolving membranes 30.

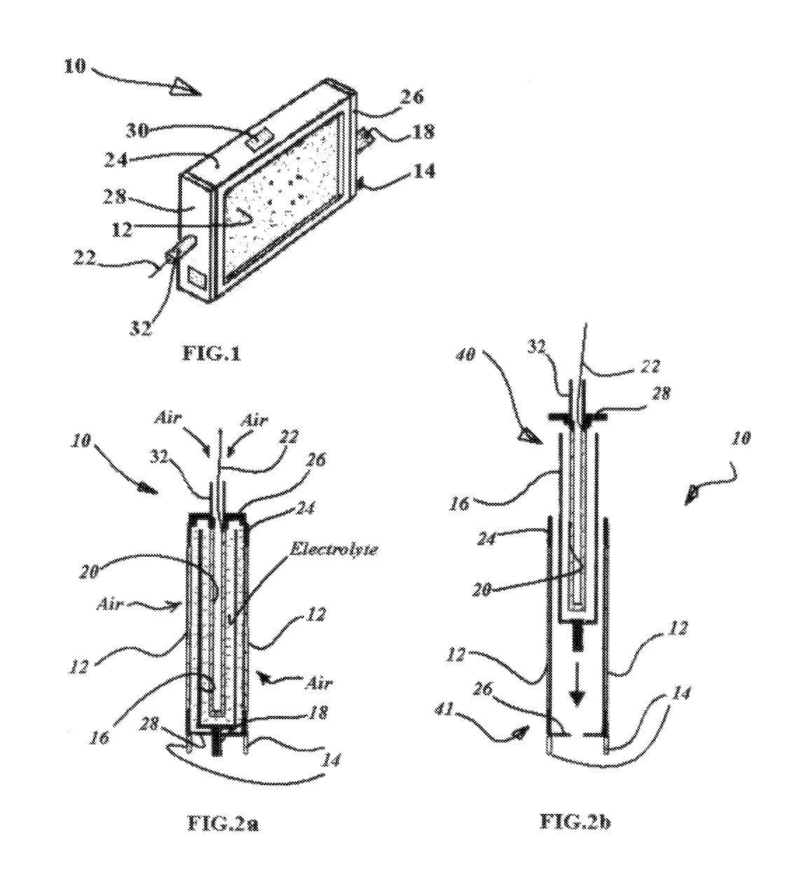

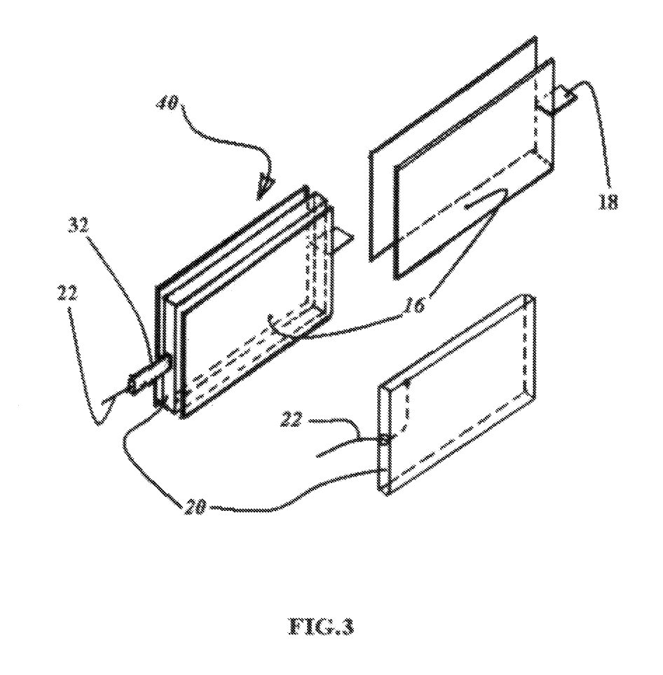

Referring now to FIG. 2a-2b, the quadruple fuel cell battery 10 includes U-shaped anode 16 and cathode box 20. The cathode unites 12, 20 and U-shaped anode 16 are in ionic interactions via electrolyte.

There are two main parts, which distinguished on the FIG. 2b. The exterior part 41 includes cathodes 12, battery frame case 24 and first case cover 26.

The interior unit 40 is comprised of the U-shaped anode 16, cathode box 20 fixed in to the cover 28 with air inlet 32 and cathode leading-out wire 22 electrically connected to the cathode box 20. FIG. 3 depicts a perspective and exploded view of the inner main part 40.

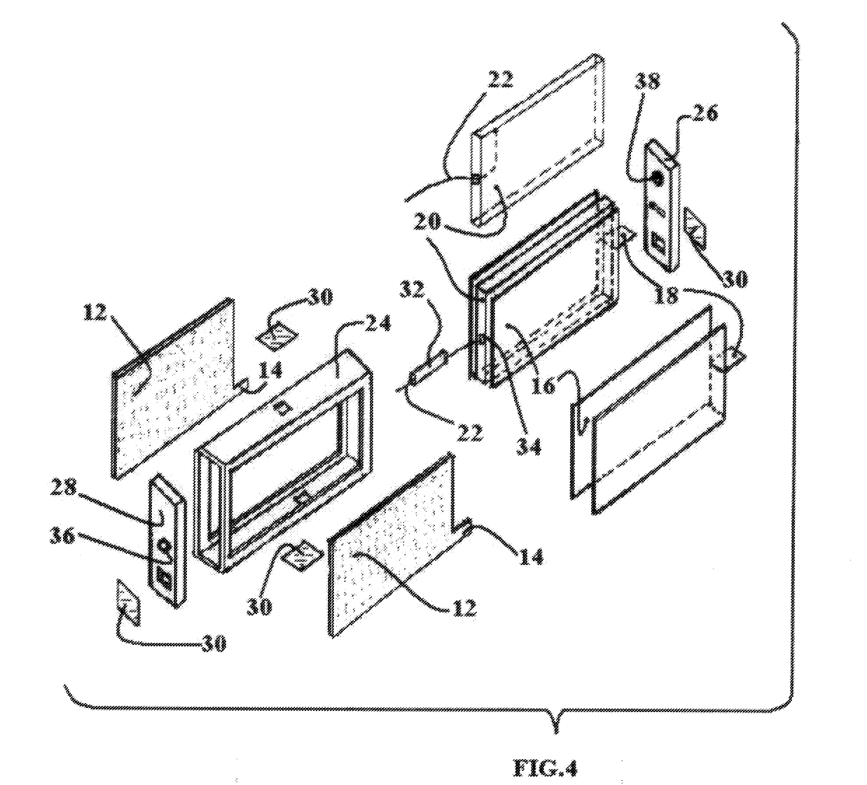

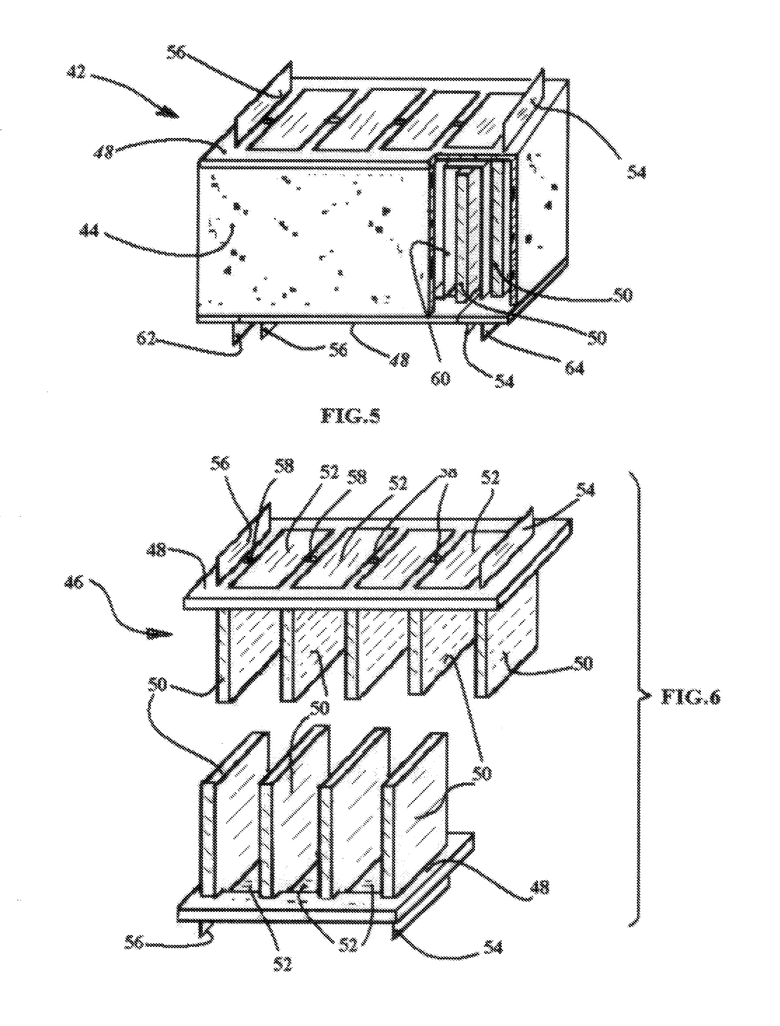

The battery 10 in exploded view is depicted in detail on the FIG. 4 but in the variant without porous layer-sandwich soaked by electrolyte because it complicates the clarity of the picture.

The airs for supporting electrochemical reaction generating power in the battery 10 are coming in two ways:—via air inlet 32 in the interior of the cathode box 20;—outside ambient air to the both cathode 12.

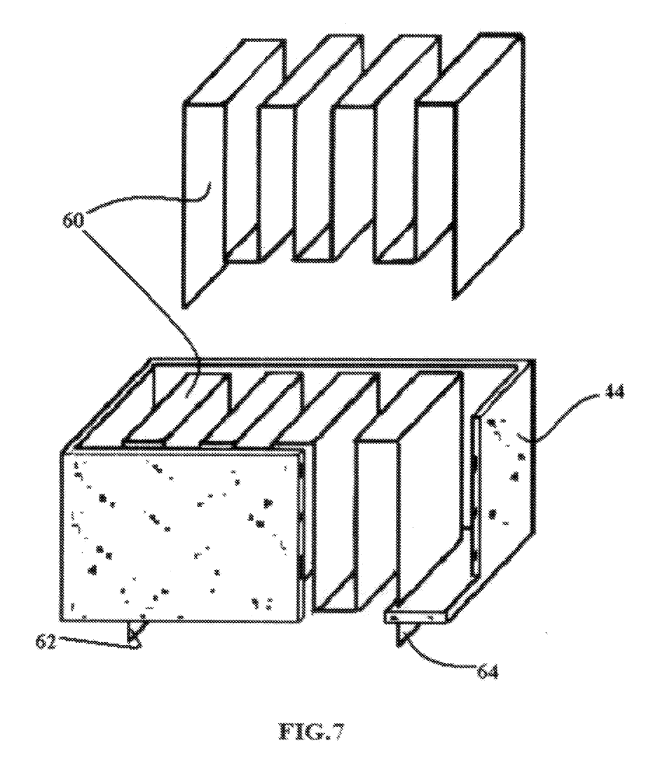

FIG. 5-7 show an embodiment of the multisectional fuel cell battery 42, which consisting of battery housing 44, anode unite 60 with taps 62,64 mounted in housing 44. The battery 42 is shown in the variant without porous layer-sandwich soaked by electrolyte because it complicates the clarity of the picture.

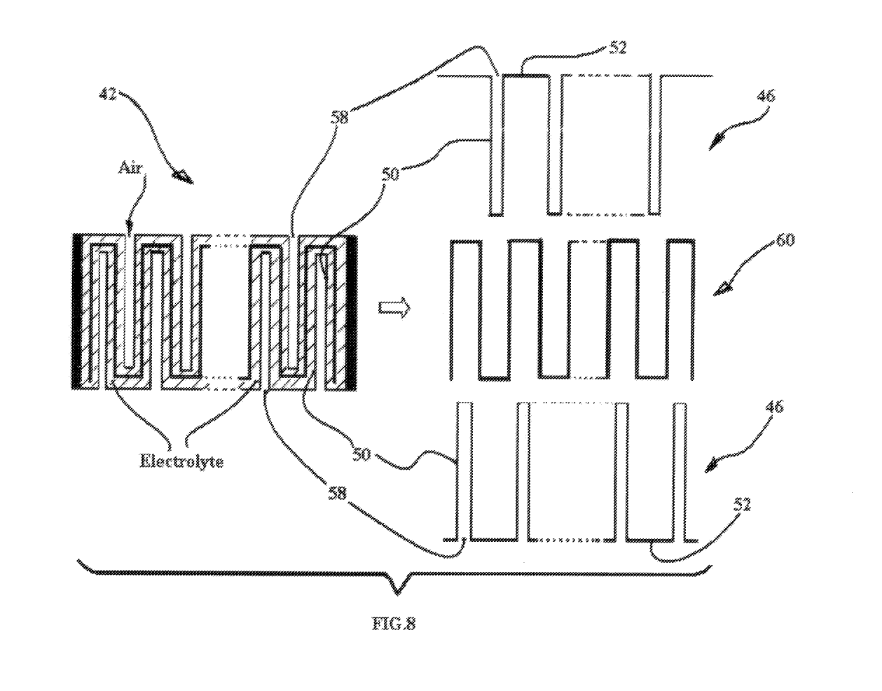

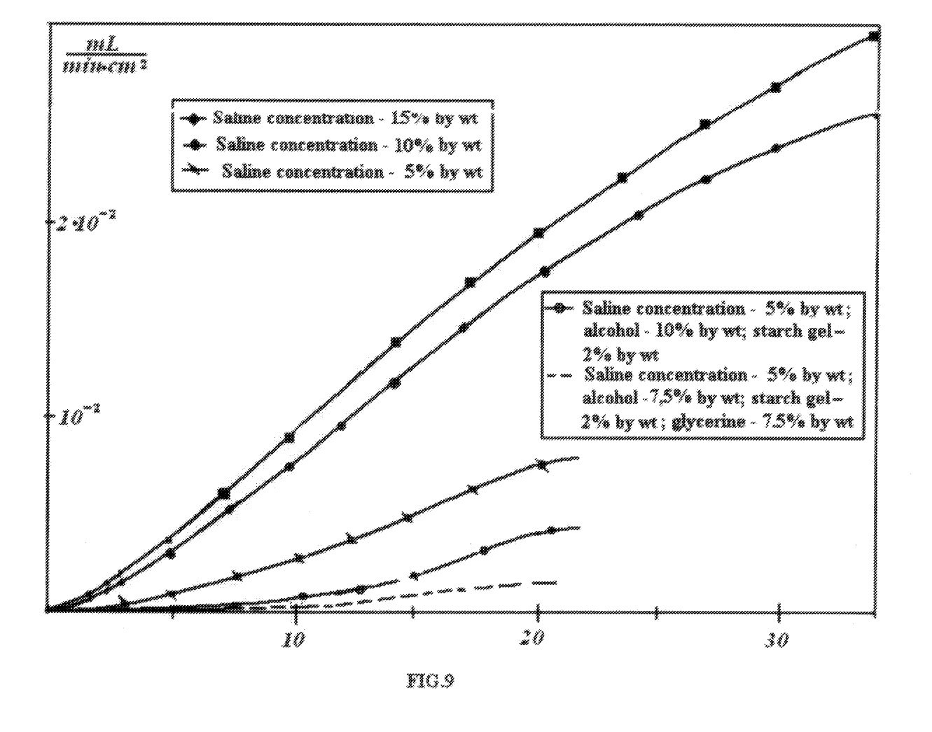

The electrochemical system of the fuel cell battery 42 includes first upper and second bottom multisectional cathode units 46, in which up and down being tie-in only to picture (See FIG. 6), and multisectional anode unit 60 (See FIG. 7) having form of the meander (See FIG. 8). The multisectional anode unit 60 and the first upper and second bottom multisectional cathode units 46 correspondingly are in ionic interactions via electrolyte.

Both multisectional cathode units 46 consist of plurality of sealed cathode box 50, cathode sheets 52 and cathode taps 54, and 56, which sealed installed in multiframe plate 48. Each cathode box 50 has air-breathing inlet 58. Air for supporting electrochemical reaction, which generating electrical power for the load, coming in following ways:—via air-breathing inlets 58;—ambient air via cathode sheet 52. Each hereinabove box 50 electrochemically interacts via electrolyte with two adjacent anodic surfaces of the meander anode 60.

Consequently, aforesaid noval design of the battery embodiments in invention can enhance output power at least twice for quadruple fuel cell battery 10 and many times for multisectional fuel cell battery 42 comparatively with prior art embodiments of the air-breathing battery.

The anode in invention can be formed of a material selected from the group consisting of aluminum, zinc, magnesium, and alloys thereof, and can comprise one or more additives of Ga, In, Sn, Cd, Pb in effective amount. The preferred anode material is aluminum alloy with indium additive which proceeding thermomechanical treatment. The preferred concentration of indium additive is within 0.2-0.6% by wt.

In the invention the preferred anodic material is formed from aluminum 99.95% purity and indium additive 0.5% by wt, which were melted in mixture to just above its melting point at about 660° C. forced air-cooled in carbon-lined, rectangular-shaped chamber having a width of 3 cm, over a period of 30 minutes, to achieve the non-equilibrium, homogeneous, crystal-forming conditions distinct from non-heterogeneous amorphous solidification.

The resultant alloy plate was hot-rolled at 500° C. to a thickness of about 3 mm and cold rolled to a thickness of about 0.5 mm, 03 mm, 0.2 mm. This proceeding provides a uniform dissolving of aluminum anode, when a current is generating under the electrochemical reaction and also fast waking up after off mode or shelf life.

The electrolyte in prior art for zinc-air battery comprises only alkaline media such as KOH, NaOH, LiOH or a combination comprising at least one of the foregoing because Zn not electrochemically active in neutral aqueous media. Usage of the alkaline media for more active metal Mg or Al (especially for Mg) as anodic material for air-breathing battery is very problematically through of the hydrogen corrosion.

FIG. 9 shows plots of changes of the hydrogen corrosion density measured in ml per min. and per square cm of the anode surface as a function of anode current density per square cm of the anode surface and saline concentrations percentage by weight. The hydrogen evolving was measured by means of the water manometer at temperature 20° C., which having precision about 0.05 ml. The size of the Al-air fuel cell under researching was 40 square cm of the cathode-anode interaction area via electrolyte. The anode plate had thickness 0.5 mm and anodic composition—aluminum 99.95% purity and indium additive 0.5% by wt. The anodic material was proceeded foregoing thermomechanical treatment.

It was found that the optimum neutral aqueous electrolyte having composition as follows: saline concentration—5% by wt; purified potato starch—2-3% by wt; alcohol (C₂H₅OH)—7.5% by wt; glycerin—7.5% by wt. During 10 hours the Al-air fuel cell was under discharged current 0.5 amp or current density about 12 ma per square cm and discharged capacity was 5 Ah. The total measured volume of the evolving hydrogen was registered about 0.8 mL. In case of the current density less then 6-8 ma per square cm the evolving hydrogen was not registered.

Thus, the preferred in invention aqueous composition of the neutral pH electrolyte is as above mentioned optimum concentration.

It is known that in a most environments where the primary metal-air will be used the cell will release water vapor from electrolyte through the air cathode and can fail due to drying out. In present invention this problem is overcoming by means of follow steps or both of them.

The starch gel and glycerin compositions provide additional effects. Firstly, this composition structures the electrolyte on the physical-chemical level in form of the 3D-matrix holding the electrolyte in microcells, which are in node points of the mentioned matrix. This effect can be enhanced by utilization porous layer-sandwich, which structuring the electrolyte on the macrolevel in the pores. Secondly, the starch gel and glycerin compositions decrease the electrolyte fluidity and increasing of the saturated vapor pressure in air plenum (air passage) 78. All mentioned effects help to overcome the problem of the drying out.

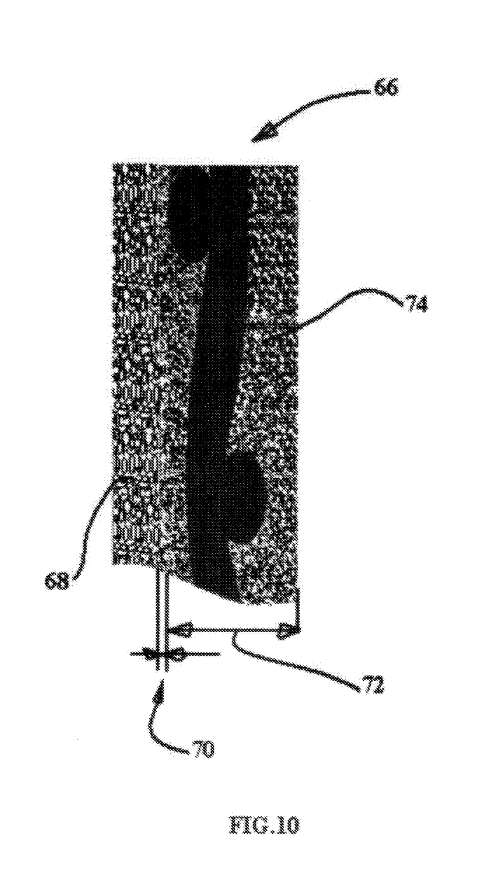

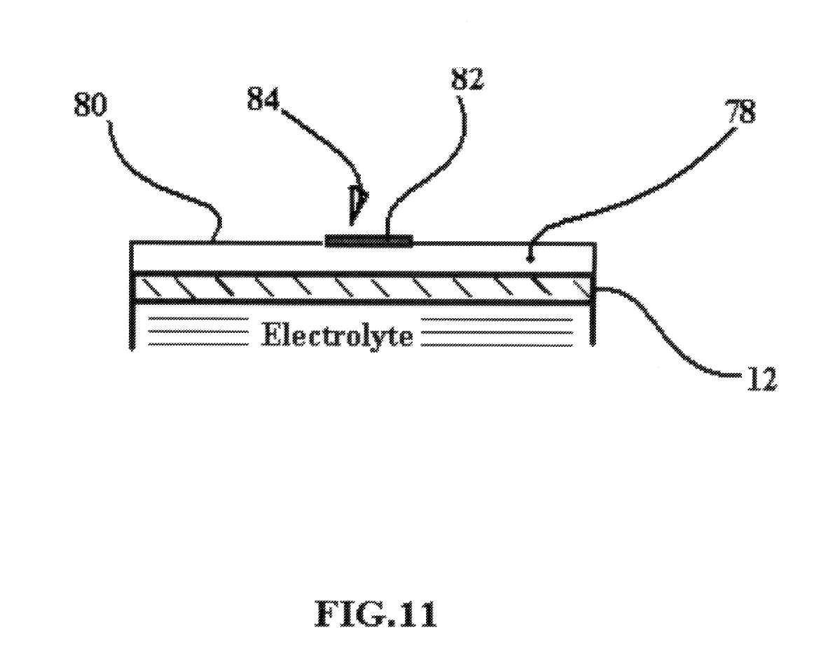

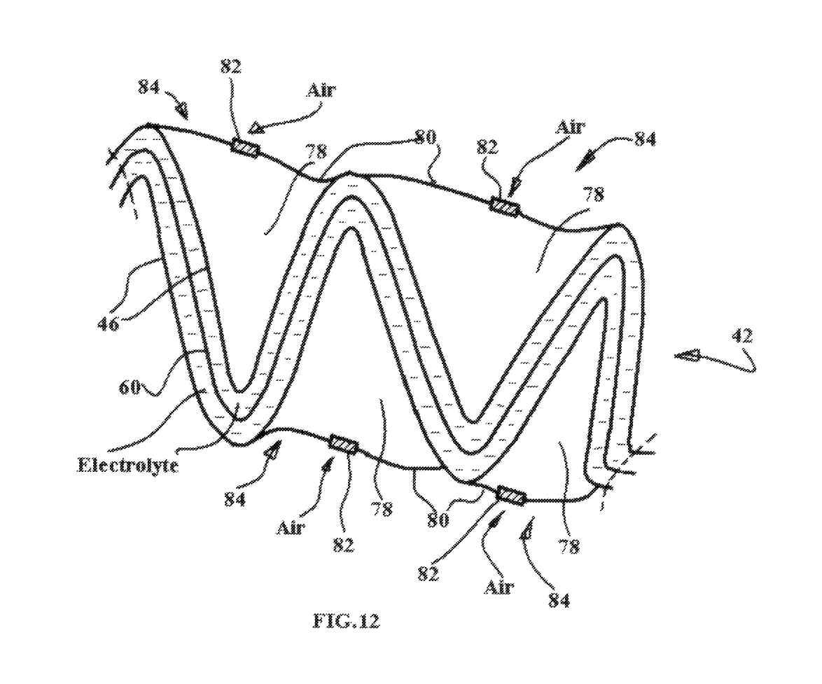

The next one is utilization of the transient layer 70 from hydrophobic 72 to hydrophilic 68 layers of the air cathode fragment 66 (gas diffusion cathode) showing on FIG. 10. Besides the current collector 74 is placed in the hydrophobic layer 72 where the current collector 74 disposed adjacent the transient layer 70. This transient layer 70 decreases the water vapor through air cathode in comparison with well-known regular air cathode having sharp boundary between hydrophobic layer and hydrophilic layer having the current collector.

Aforesaid air/gas diffusion cathode preferably is the thermoplastic composite materials and consists of multi-layers having at least a current collector mesh, preferably with dendritic protrusions, selected from inert metal such as nickel, copper or aluminum coating by one from the Au, Ni, Pb, Sn, a gas non-permeable hydrophilic active layer consisting of a high dispersion porous carbon and a gas permeable hydrophobic layer preferably from the porous carbon. The hydrophobic and the hydrophilic active layers can be catalysed by noble metals such as Pt—Pd or Ag or silver oxide or/and complex macrocycles or chelates such as carbon fullerenes or carbon nanotubes.

In general, if not taking in account the additional transient layer 70 gas diffusion cathode 66 is similar to oxygen/air electrode used to use in convenient metal-air battery/fuel cell in various way. See, for example, U.S. Pat. Nos. 4,448,856, 4,885,217, 5,312,701, 5,441,823, 6,127,061, 6,203,940 and so on. These references can be assist to construct of the gas diffusion cathode.

The more effective step decreasing water vapor from electrolyte through the air cathode is as follows. The film mask 80 covering the air cathode 12, which is above mentioned air cathode sheet 12 or 52, in the manner FIG. 11 making an air plenum 78 between inner surface of the mask 80 and external surface of the air cathode 76 facing outside. The hole(s) 84 in the mask 80 are closed by means of the hydrophobic gas permeable membrane 82, which is above-mentioned membrane 30. In the variant of the cathode box 20 or 50 the hole 84 is adequate to the air inlet tubule 32 or air breathing inlet 58, which are properly sized and closed by the membrane 82.

The membrane effectiveness (or permeability) is usually defined by the known Gurley number Ng [sec.], which is a time during the 100 mL of the gas passing in ambient air through square inch of this membrane by the pressure 1.01 atmospheres.

Thus, the value of Ng and size of the holes 84 (closed by membrane) have to be defined in accordance with electrochemical reaction which takes place in metal-air fuel cell, preferably Al-air fuel cell. It means that the pressure difference between air plenum 78 and ambient air has to force sufficient amount of oxygen passing through the membrane area(s) 82 being on the hole 84 or each holes 84. By means of water manometer the mentioned pressure difference was measured for current I=0.5 Amp. It was found that pressure the inside of the air plenum 78 closing 40 square cm of the cathode area was less then outside ambient on the value 0.01 Atm. So, if the size of the hole(s) 84 closed by the membrane having Gurley Number Ng were 1 square inch then the volume of gas (O2, CO2 etc) penetrated through membrane would be 60/Ng×100 mL per min. For the hole(s) 84 having total area Sh square cm the volume of the penetrated gas per min will be

Vml=9×Sh/Ng×10² mL per min.

Generation of current I from the fuel cell needs an adequate amount of air penetrated through the membrane 82 with area Sh to the plenum 78 of the air cathode 76. Taking into consideration aforesaid information the total area of the membrane can be sized in the following condition:

Sh≧1.83×Ng×10⁻²×(I[Amp]/0.5 Amp)square cm,

where
Sh[square cm]—total area of the hole(s) covered by membrane having penetration rate Ng,
I[Amp]—required current generated by fuel cell.

Thus the area Sh square cm of the hole or total area of the holes covered by membrane with penetrating rate Ng should be at least 1.83×Ng×10⁻²×(I[Amp]/0.5 Amp) square cm.

For example, if the required current generated by fuel cell is 0.5 Amp and Gurley Number of the membrane Ng=15 sec., then the total area of the membrane should be at least ˜0.3 square cm.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A metal air fuel cell comprising:
a housing;
a cathode;
the housing having an air passage through which air can pass to the cathode, the air passage being sealed by a gas permeable membrane;
an anode made of a metal selected from the group comprising aluminum, zinc, magnesium, and alloys thereof;
the cathode and anode being electrochemically coupled by an electrolyte such that the cathode and anode are capable of electrochemically reacting to consume O₂ gas at a volume rate of V when producing a desired electrical current of I, and
the gas permeable membrane having a gas permeability rate and a surface area through which O₂ gas can pass through the gas permeable membrane to the cathode, the surface area and the gas permeability rate of the gas permeable membrane selected to permit O₂ gas to pass through the membrane at a rate Vₘ substantially equal to V at the desired current I.

2. The metal air fuel cell of claim 1 wherein the gas permeable membrane is configured to restrict the passage of water vapor through the gas permeable membrane.

3. The metal air fuel cell of claim 2 wherein the gas permeable membrane is hydrophobic.

4. The metal air fuel cell of claim 1 wherein the electrolyte is carried in a gel matrix having a plurality of micro-cells.

5. The metal air fuel cell of claim 4 wherein the gel matrix is formed from starch and glycerin.

6. The metal air fuel cell of claim 5 wherein the electrolyte comprises a substantially pH neutral gelled solution of saline at a concentration of about 5% by weight, starch at a concentration of about 2% to about 3% by weight, alcohol at a concentration of about 7.5% by weight and glycerin at a concentration of about 7.5% by weight.

7. The metal air fuel cell of claim 6 wherein the electrolyte is contained in a porous cellulose layer.

8. The metal air fuel cell of claim 1 wherein the cathode comprises a three layered cathode having a substantially gas impermeable hydrophilic layer, a gas permeable hydrophobic layer containing a current collector mesh and a transition layer between the hydrophobic and hydrophilic layers, the transition layer being progressively more hydrophilic from the hydrophobic layer towards the hydrophilic layer.

9. A metal air fuel cell comprising:
a housing;
a first pair of flat cathodes contained in a parallel orientation within the housing;
the housing having first air passages through which air can pass to the first pair of flat cathodes;
a first pair of flat anodes positioned between the first pair of flat cathodes and extending parallel thereto, the anodes being made of a metal selected from the group comprising aluminum, zinc, magnesium, and alloys thereof;
a second pair of flat cathodes positioned between the first pair of flat anodes and extending substantially parallel thereto, the second pair of flat cathodes enclosing a second air passage, the second air passage being coupled to the housing to permit air to pass to the second pair of cathode plates;
the first and second pairs of cathode plates being electrochemically coupled by an electrolyte to the first pair of anode plates, the electrolyte selected such that the anode plates and the cathode plates are capable of electrochemically reacting to consume O₂ gas to produce a desired electrical current.

10. The metal-air fuel cell of claim 9 wherein the first pair of cathode plates are made from a first single elongated flat cathode which has been folded into first parallel portions and wherein the first anode plates are made from a single elongated flat anode which has been folded into second parallel portions and wherein the second pair of cathode plates are made from a second single elongated flat cathode which has been folded into third parallel portions.

11. The metal-air fuel cell of claim 10 wherein the first single elongated flat cathode is corrugated to form a plurality of first parallel portions each having a parallel pair of flat cathode plates and wherein the single elongated flat anode is corrugated to form a plurality of second parallel portions each having a parallel pair of flat anode plates and wherein the second elongated flat cathode is corrugated to form a plurality of third parallel portions each having a parallel pair of flat cathode plates separated by a second air passage, the first and second single elongated flat cathodes being aligned with each other and with the first single elongated flat anode such that the first, second and third parallel portions are aligned with each other each third parallel portion is nestled within a corresponding second parallel portion which is in turn nestled within a corresponding first parallel portion.

12. The metal-air fuel cell of claim 11 wherein a plurality of first air passages are formed between adjacent first parallel portions, the plurality of first air passages being coupled to the housing such that air can pass to the parallel pairs of flat cathode plates formed in the first single elongated flat cathode and wherein the housing is further configured to couple to the second air passages such that air can pass to the parallel pairs of flat cathode plates formed in the second single elongated flat cathode.

13. The metal-air fuel cell of claim 9 wherein the first and second pairs of cathode plates electrochemically react with the anode to consume O₂ gas at a rate of V when producing a desired electrical current of I, and wherein the first and second air passages are sealed by a gas permeable membranes, the gas permeable membranes each having an O₂ gas permeability rate and a surface area through which O₂ can pass to the first and second cathodes, the surface area and the gas permeability rate of the membranes selected to permit O₂ gas to pass through the membranes at a rate Vₘ substantially equal to V at the desired current I.

14. The metal-air fuel cell of claim 9 wherein the electrolyte is carried in a gel matrix having a plurality of micro-cells.

15. The metal air fuel cell of claim 14 wherein the gel matrix is formed from starch and glycerin.

16. The metal air fuel cell of claim 15 wherein the electrolyte comprises a gelled solution of saline at a concentration of about 5% by weight, starch at a concentration of about 2% to about 3% by weight, alcohol at a concentration of about 7.5% by weight and glycerin at a concentration of about 7.5% by weight, the electrolyte being soaked into a porous cellulose layer.

17. The metal air fuel cell of claim 9 wherein the first, second, third and fourth cathodes each comprise a three layered cathode having a substantially gas impermeable hydrophilic layer, a gas permeable hydrophobic layer containing a current collector mesh and a transition layer between the hydrophobic and hydrophilic layers, the transition layer being progressively more hydrophilic from the hydrophobic layer towards the hydrophilic layer.

18. The metal-air fuel cell of claim 9 wherein the metal forming the anode comprises a metal having an additive selected from the group comprising Ga, In, Sn, Cd and Pb.

19. The metal-air fuel cell of claim 18 wherein the anode is made of an Al—In alloy formed from Aluminum having 99.95% purity and In in about 0.2 to 0.6% by weight.

20. The metal-air fuel cell of claim 19 wherein the anode has a homogeneous crystal structure.

21. The metal-air fuel cell of claim 20 wherein the Al—In alloy is first melted at 660° C. and then cooled into alloy plates in non-equilibrium, homogeneous crystal-forming conditions and then the alloy plates are cold rolled to form the anode.

22. A method of forming an anode for use with the metal-air fuel cell defined in claims 1 and 9 comprising:
melting a first metal selected from the group comprising aluminum, zinc, magnesium and alloys thereof with an additive selected from the group comprising Ga, In, Sn, Cd, Pb to a first temperature to form a melt, the first temperature selected to be just above the melting point of the selected metals and additives;
cooling the melt under non-equilibrium, homogeneous crystal forming conditions to form an alloy plate with a homogeneous crystal structure, and then cold working the alloy plate to a desired thickness.
